(19) United States
(12) Patent Application Publication
(10) Pub. No.: US 2012/0146438 A1
(43) Pub. Date: Jun. 14, 2012

(54) Electromagnetic Brake and Electric Motor

(75) Inventors: Hitoshi IDE, Kamagaya (JP); Akio Imai, Chiba (JP); Hidekazu Matsui, Sakura (JP)

(73) Assignee: Hitachi Industrial Equipment Systems Co., LTD., Tokyo (JP)

(21) Appl. No.: 13/164,169

(22) Filed: Jun. 20, 2011

(30) Foreign Application Priority Data
Dec. 10, 2010 (JP) 2010-275241

(51) Int. Cl. H02K 7/102; F16D 55/30; F16D 55/38; F16D 55/24

(52) U.S. Cl. 310/77; 188/72.3

(57) ABSTRACT

To provide an electromagnetic brake and an electric motor in which, in the case of using the motor with its shaft thereof in a vertical position, static friction torque and dynamic friction torque caused by electromagnetic brake portions is reduced, thereby enabling to provide reliable motor torque on the motor output shaft, and stable braking. The electromagnetic brake includes: a hub attached to a rotating shaft and rotated with rotation of the rotating shaft; a friction plate rotated in engagement with the hub and movable in an axial direction; brake plates sandwiching the friction plate, held against rotation by the rotating shaft, and movable in the axial direction; a brake plate retainer for fixing the brake plates in a direction of shaft rotation and retaining the brake plates in an axially movable manner; a pressure transmitter for receiving pressure and pressing the brake plates; a pressure generating mechanism for generating pressure to be applied to the pressure transmitter; and a stress generating mechanism for generating stress against the pressure applied to the pressure transmitter. Also, a stepped portion is provided on at least one of the brake plate retainer and the hub.

This application claims the priority of Japanese Patent Application No. JP 2010-275241, filed Dec. 10, 2010, the disclosure of which is expressly incorporated by reference herein in its entirety.

### TECHNICAL FIELD

The present subject matter relates to an electromagnetic brake and an electric motor.

### BACKGROUND

Japanese Published Unexamined Patent Application No. 558-88234 (Patent Literature 1) is referred to as the related art. Patent Literature 1 discloses an electromagnetic brake composed of: a brake wheel attached to a rotating shaft; a brake disc facing the brake wheel, and prevented from rotating in the rotational direction while being allowed to move axially; a lever and a brake spring for pressing the brake disc against the brake wheel; and a magnet that releases the brake disc from the brake wheel against the spring force of the brake spring and is joined to the lever. Also, the operation of this electromagnetic brake is disclosed as follows: When current is simultaneously applied to the magnet and a motor, the magnet is magnetized to attract a movable piece. The lever then turns clockwise, and a protruding portion is moved to the right to release the force pressing the brake disc, so that the brake is released. When the current is interrupted, the magnet is demagnetized, and the lever is turned counterclockwise by the return force of the brake spring to press the brake disc with the protruding portion, so that the brake is applied.

In addition, Japanese Published Unexamined Patent Application No. 2008-39107 (Patent Literature 2) is also referred to as the related art. Patent Literature 2 discloses a disc brake in which positioning means is provided for positioning a disc when moved toward an armature by the magnetic force of a magnet coil in the energized state of the magnet coil, in such a manner that a space is kept both between an armature-side lining and the disc and between a plate-side lining and the disc, thereby suppressing the occurrence of abnormal noise and wear caused by the contact of the disc with the plate during non-braking.

In the case of using the motor with its shaft in a position other than horizontal, for example in a vertical position, in Patent Literature 1, when the magnet is magnetized, the force pressing the brake disc is released to cause the brake disc and the brake wheel to fall by gravity in an axial direction, so that the whole upper and lower surfaces of the brake disc and the brake wheel are kept in contact with each other. Thus, static friction torque against starting torque caused at the time of starting operation of the motor is generated, which has caused a decrease in the performance of the motor as a friction loss. Also, during operation of the motor, dynamic friction torque against the motor torque is generated, which has caused a decrease in the efficiency of the motor as a friction loss. Further, this has caused a reduction in the lifetime of a brake plate and a friction plate brought into contact with each other during rotation of the motor.

In Patent Literature 2, the above-described structure is designed in view of a reduction in the friction loss that is caused due to generation of the friction torque against the motor torque. However, since it is necessary to newly provide a component such as a magnet, there has been a problem that the cost increases due to increases in the installation space and number of components.

### SUMMARY

Accordingly, an object of the present invention is to provide: an electromagnetic brake in which, even in the case of using a motor with an output shaft thereof in a position other than horizontal, for example in a vertical position, unnecessary static friction torque and dynamic friction torque caused by electromagnetic brake components against the torque generated during operation of the motor is reduced with simple structure, thereby enabling stable starting torque of the motor; and an electric motor with the electromagnetic brake.

According to an aspect of the present invention, an electromagnetic brake includes: a hub attached to a rotating shaft and rotated with rotation of the rotating shaft; a friction plate rotated in engagement with the hub and movable in an axial direction; plural brake plates sandwiching the friction plate, held against rotation by the rotating shaft, and movable in the axial direction; a brake plate retainer for fixing the brake plates in a direction of shaft rotation and retaining the brake plates in an axially movable manner; a pressure transmitter for receiving pressure and pressing the brake plates; a pressure generating mechanism for generating pressure to be applied to the pressure transmitter; a stress generating mechanism for generating stress against the pressure applied to the pressure transmitter; and a brake plate retainer stepped portion provided on the brake plate retainer between adjacent ones of the plural brake plates. The number of contact surfaces of the brake plates with the friction plate is reduced by the brake plate retainer stepped portion.

According to an aspect of the present invention, it is possible to provide a highly reliable electric motor with improved performance.

### BRIEF DESCRIPTION OF THE SEVERAL VIEWS OF THE DRAWINGS

The drawing figures depict one or more implementations in accord with the present teachings, by way of example only, not by way of limitation. In the figures, like reference numerals refer to the same or similar elements.

FIG. 1 is a longitudinal sectional view of an electric motor with an electromagnetic brake according to embodiments of the present invention;

FIG. 2 is a front elevation view of the electric motor with the electromagnetic brake according to a first embodiment of the present invention;

FIG. 3 is a longitudinal sectional view (a sectional view taken along A-A of FIG. 2) of the electromagnetic brake according to the first embodiment of the present invention;

FIG. 4 is an assembly diagram (a sectional view taken along B-B of FIG. 2) of friction plates, brake plates and brake plate retainers of the electromagnetic brake according to the first embodiment of the present invention;

FIG. 5 is an assembly diagram (a sectional view taken along C-C of FIG. 2) of pressure transmitters, the friction plates, and the brake plates of the electromagnetic brake according to the first embodiment of the present invention;

FIG. 6 is a structure diagram of an end bracket, a hub, brake plates, friction plates, and brake plate retainers when an electric motor according to the known art is used with its shaft in a vertical position;

FIG. 7 is a structure diagram of an end bracket, a hub, the friction plates, the brake plates, and the brake plate retainers when the electric motor with the electromagnetic brake according to the first embodiment of the present invention is used with its shaft in a vertical position;

FIG. 8 is a front elevation view of an electric motor with an electromagnetic brake according to a second embodiment of the present invention;

FIG. 9 is a mounting diagram (a sectional view taken along B-B of FIG. 8) of friction plates, brake plates, and a hub of the electromagnetic brake according to the second embodiment of the present invention;

FIG. 10 is a structure diagram of an end bracket, the hub, the friction plates, the brake plates, and brake plate retainers when the electric motor with the electromagnetic brake according to the second embodiment of the present invention is used with its shaft in a vertical position;

FIG. 11 is a front elevation view of an electric motor with an electromagnetic brake according to a third embodiment of the present invention;

FIG. 12 is a mounting diagram (a sectional view taken along B-B of FIG. 11) of friction plates, brake plates, brake plate retainers, and a hub of the electromagnetic brake according to the third embodiment of the present invention; and

FIG. 13 is a structure diagram of an end bracket, the hub, the friction plates, the brake plates, and the brake plate retainers when the electric motor with the electromagnetic brake according to the third embodiment of the present invention is used with its shaft in a vertical position.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

### First Embodiment

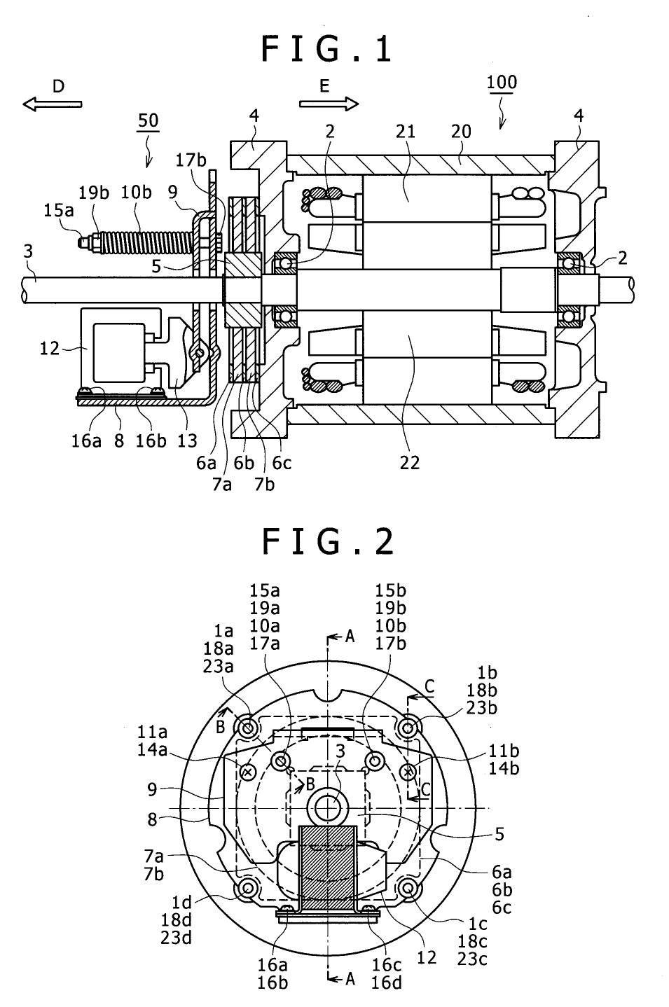

Hereinafter, embodiments of the present invention will be described with reference to the accompanying drawings. A first embodiment of an electric motor with an electromagnetic brake according to the present invention will be described. Firstly, the basic structure of the electric motor with the electromagnetic brake will be described with reference to FIG. 1. FIG. 1 is a longitudinal sectional view of the electric motor with the electromagnetic brake.

As shown in FIG. 1, an electric motor 100 is constructed in such a manner that a rotating shaft 3 with both ends rotatably supported by end brackets 4 through bearings 2; a rotor 22 provided around the rotating shaft 3; and a stator 21 that is provided on the outer side of the rotor 22 and around which coils are wound, are stored in a casing composed of an annular housing 20 and the end brackets 4. An electromagnetic brake 50 is attached to the rotating shaft 3 extending outwardly of the electric motor 100 from the end brackets 4.

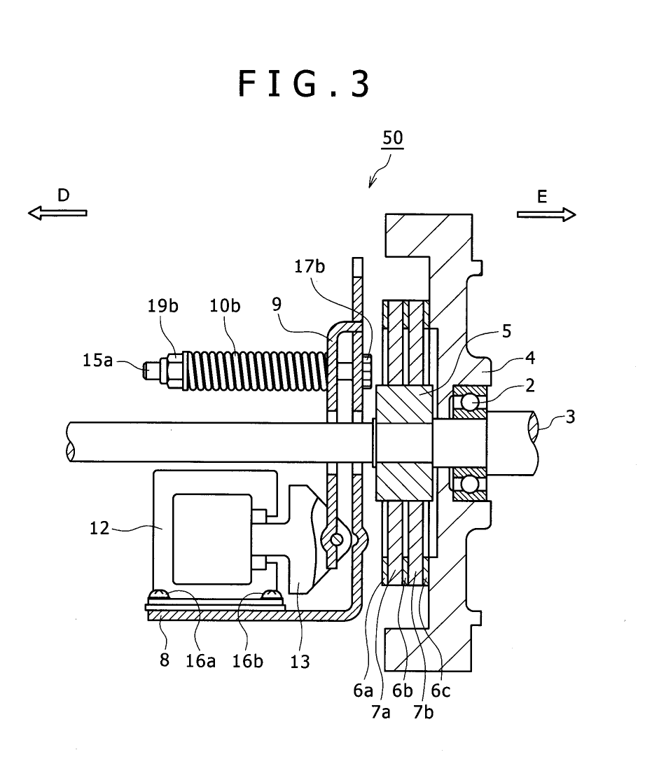

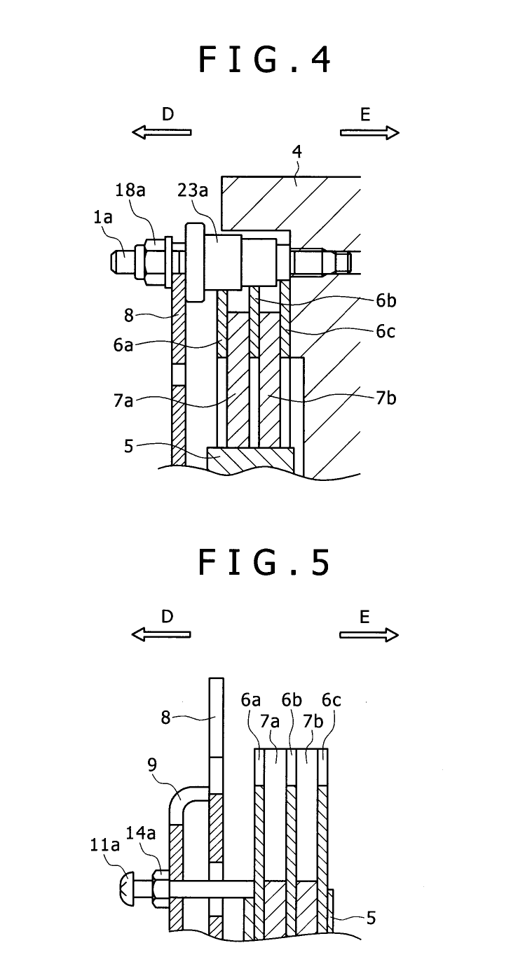

Next, the structure of the electromagnetic brake according to this embodiment will be described with reference to FIGS. 2 to 4. FIG. 2 is a front elevation view of the electric motor with the electromagnetic brake; FIG. 3 is a longitudinal sectional view of the electromagnetic brake, as viewed from line A-A of FIG. 2; FIG. 4 is an assembly diagram of brake plates and a brake plate retainer, as viewed from line B-B of FIG. 2; and FIG. 5 is an assembly diagram of a pressure transmitter, friction plates, and the brake plates, as viewed from line C-C of FIG. 2.

Firstly, the structure of the electromagnetic brake according to this embodiment will be described with reference to FIG. 2. FIG. 2 is a front elevation view of the electric motor with the electromagnetic brake according to this embodiment, as viewed in the direction of from D to E in FIG. 1.

As shown in FIG. 2, the electric motor is provided with the rotating shaft 3 in the center, and a hub 5 is fitted to the rotating shaft 3 in such a manner as to rotate with rotation of the rotating shaft 3. Disc-shaped friction plates 7a and 7b are provided on outer edges of the hub 5. The friction plates 7a and 7b, facing each other, are engaged with the hub 5 in such a manner as to be rotatable and movable in the axial direction of the rotating shaft 3. Also, brake plates 6a, 6b, and 6c each having a square-shaped periphery and a circular hole inside are provided in such a manner as to sandwich the friction plates 7a and 7b therebetween. The brake plates 6a, 6b, and 6c are each retained at the four corners thereof by brake plate retainers 1a to 1d.

Further, the four brake plate retainers 1a to 1d are engaged with a mounting plate 8, and the mounting plate 8 is fixed by mounting plate fixing nuts 18a to 18d. A movable plate 9 is provided on the mounting plate 8. Tension applying members 10a and 10b are respectively attached to the movable plate 9 by rods 15a and 15b, rod fixing nuts 17a and 17b, and tension retaining nuts 19a and 19b. Also, pressure transmitters 11a and 11b are attached to the movable plate 9 by locknuts 14a and 14b, respectively. Additionally, an electromagnet fixing portion 12 and an electromagnet movable portion 13 are provided on the opposite side of the rotating shaft from the tension applying members 10a and 10b.

FIG. 3 is a longitudinal sectional view of the electromagnetic brake according to this embodiment, as viewed from the section A-A of FIG. 2. As shown in FIG. 2, the disc-shaped friction plates 7a and 7b are provided on the outer edges of the hub 5 fitted to the rotating shaft 3, and the brake plates 6a, 6b, and 6c are retained by the brake plate retainers 1a to 1d (not shown), in such a manner as to sandwich the friction plates 7a and 7b therebetween.

The mounting plate 8 is attached to the brake plate retainers 1a to 1d, and the movable plate 9 is engaged with the mounting plate 8. Also, a mechanism for generating pressure to urge the movable plate 9 in direction E so as to brake the rotating shaft 3 is provided on the movable plate 9. In this embodiment, the tension applying member 10b serves as this mechanism. The tension applying member 10b is provided around the periphery of the rod 15b, with the rod 15b as its center. The tension retaining nut 19b retains the tension and position of the tension applying member 10b between the tension retaining nut 19b and an end face of the movable plate 9. The rod 15b is fixed to the mounting plate 8 by the rod fixing nut 17b.

Furthermore, a mechanism for generating stress against the pressure for braking the rotating shaft 3, that is, the stress for releasing the brake, is provided on the mounting plate 8 and the movable plate 9. In this embodiment, this mechanism is composed of the electromagnet movable portion 13 attached to the movable plate 9, and the electromagnet fixing portion 12 attached to the mounting plate 8 by fixing screws 16a and 16b. With this structure, the electromagnet movable portion 13 is sucked and moved by the electromagnet fixing portion 12, thereby causing the movable plate 9 to operate so as to generate stress against the pressure for braking the rotating shaft 3.

FIG. 4 is an assembly diagram of the brake plates and the brake plate retainers according to this embodiment, as viewed from the section B-B of FIG. 2. As shown in FIG. 4, the brake plates 6a, 6b, and 6c according to this embodiment have mutually different diameters, and the increasing order of diameter is 6a, 6b, and 6c. In addition, the brake plates 6a, 6b, and 6c are each retained by the brake plate retainer la, and the brake plate retainers 1b to 1d not shown in the figure.

Next, the shape of the brake plate retainer la will be described. It should be noted that the brake plate retainers 1a to 1d have the same shape.

The brake plate retainer la has a stepped portion 23a. The stepped portion 23a is formed of a row of cylinders having different diameters, and has a structure with the respective cylinders increasing in diameter in order from a side closer to the end bracket 4. The differences in diameter among these cylinders form steps. In this embodiment, the stepped portion 23a has a row of four cylinders having different diameters, and thus includes three steps. The stepped portion 23a is designed to retain the brake plates 6a, 6b, and 6c falling by gravity, in the case of using the motor with its shaft in a vertical position. It should be understood that the structure of the stepped portion is not limited to this embodiment, and a stepped portion not having the structure with cylinders arranged in a row is acceptable if the stepped portion has a step structure. It should be also understood that the number of steps is not limited to three and may be determined as appropriate depending on the numbers of the friction plates and the brake plates. While not shown in FIG. 4, the brake plate retainer 1b has a stepped portion 23b; the brake plate retainer 1c has a stepped portion 23c; and the brake plate retainer 1d has a stepped portion 23d. The stepped portions 23a to 23d are of the same shape.

The brake plate retainer la having the stepped portion 23a is threadably mounted on the end bracket 4, in engagement with one of the four edges of each of the brake plates 6a, 6b, and 6c. Also, the mounting plate 8 is attached to the brake plate retainer 1a by the mounting plate fixing nut 18a.

FIG. 5 is an assembly diagram of the pressure transmitters, the friction plates, and the brake plates, as viewed from the section C-C of FIG. 2. As shown in FIG. 5, the pressure transmitter 11a for pressing the brake plate 6a with the stress caused by operation of the movable plate 9 is locked in the movable plate 9 provided on the mounting plate 8 by the locknut 14a. The pressure transmitter 11a can pass through a through-hole of the mounting plate 8 to press an end face of the brake plate 6a.

Next, the braking operation of the electromagnetic brake will be described. The electromagnetic brake according to this embodiment is a non-excitation braking mechanism in which the electric motor is braked in a non-excited state by the braking mechanism.

In FIG. 3, the electric motor 100 is connected to an exciting power source (not shown). Also, the exciting power source is commonly-connected to the electromagnet fixing portion 12. Upon the passage of exciting current through the electromagnet fixing portion 12, the electromagnet movable portion 13 moves in a direction to be sucked by the electromagnet fixing portion 12, that is, in direction D. The electromagnet movable portion 13 is engaged with the movable plate 9, and therefore, when the electromagnet movable portion 13 is sucked by the electromagnet fixing portion 12, the movable plate 9 pivots in the direction D about a contact point between the movable plate 9 and the mounting plate 8.

Further, as shown in FIG. 5, in response to the operation of the movable plate 9, the pressure transmitters 11 attached to the movable plate 9 pass through the mounting plate 8 to move in the direction D. When the pressure transmitters 11 move in the direction D, the contact of the brake plates 6 urged toward the end bracket 4 with the pressure transmitters 11 is released to allow the brake plates 6 to move axially and freely and allow the friction plates 7 to rotate in the direction of shaft rotation, so that the electromagnetic brake comes into a released state, i.e. a non-braking state.

When the excitation power applied to the electric motor is shut off, the suction force of the electromagnet fixing portion 12 acting on the electromagnet movable portion 13 is released, and the movable plate 9 is moved in the direction E by the action of the tension applying members 10. In response thereto, the pressure transmitters 11 attached to the movable plate 9 move in the direction E. Thus, the brake plates 6 and the friction plates 7 are urged toward the end bracket 4 and locked, so that the electromagnetic brake comes into an operating state, i.e. a braking state.

Although the non-excitation braking mechanism is employed in this embodiment, the present invention is not limited to this embodiment. Alternatively, an excitation braking mechanism may be used, in which the electric motor is braked in an excited state by the braking mechanism.

Furthermore, in this embodiment, the electromagnet movable portion 13 is pulled and moved by the electromagnet fixing portion 12, thereby causing the movable plate 9 to operate and generate stress against the pressure exerted on the brake plates 6a to 6c so as to release the braking state. However, the present invention is not limited to this embodiment, and any structure including a stress generating mechanism for generating stress against the pressure exerted on the brake plates so as to release the braking state may be employed.

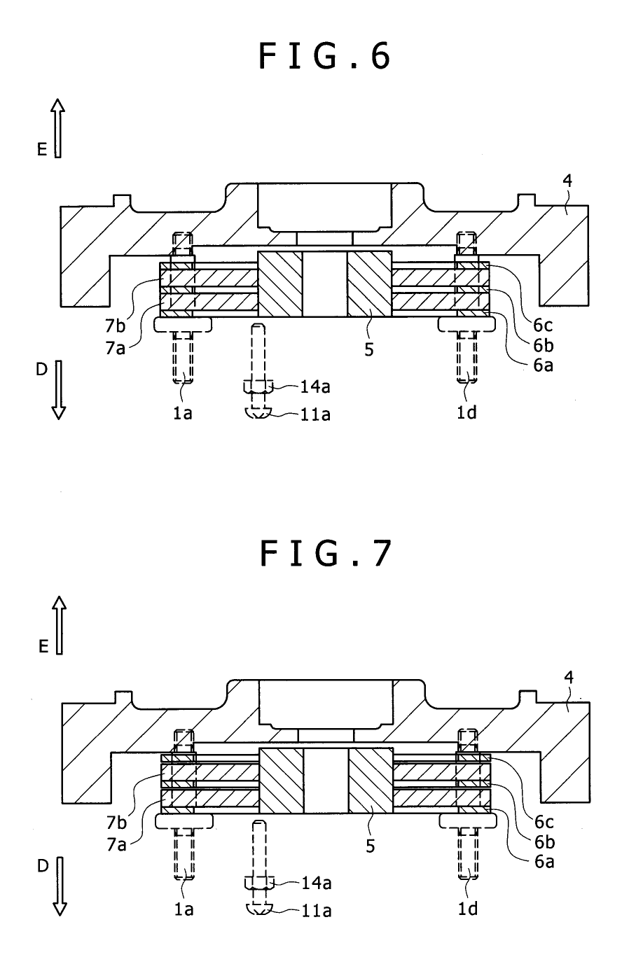

Next, the operation, in the case of using the motor with its shaft in a position other than horizontal, for example in a vertical position, will be described. Here, the description is made by comparing the structures of the known art in FIG. 6 and the present invention in FIG. 7.

FIG. 6 is a structure diagram of an end bracket, a hub, friction plates, brake plates, and brake plate retainers when an electric motor according to the known art is used with its shaft in a vertical position.

When the electric motor is used with its shaft in a vertical position, the brake plates 6a, 6b, and 6c, and the friction plates 7a and 7b fall by gravity to the brake plate retainers 1a to 1d in a stacked relationship thereon, during non-braking. At this time, the number of contact surfaces of the brake plates 6a, 6b, and 6c with the friction plates 7a and 7b is four. This causes static friction torque and dynamic friction torque acting opposite to the direction of motor torque, leading to increased losses in the electric motor.

FIG. 7 is a structure diagram of the end bracket, the hub, the brake plates, the friction plates, and the brake plate retainers when the electric motor with the electromagnetic brake according to the first embodiment of the present invention is used with its shaft in a vertical position. In the case of using the motor with its shaft in a vertical position with the use of the structure of the electromagnetic brake according to this embodiment as shown in FIG. 7, the brake plates 6a, 6b, and 6c, during non-braking, fall by gravity to be held on the stepped portions 23a to 23d provided on the brake plate retainers 1a to 1d, thereby forming a space in the rotating shaft direction between the friction plate 7a and the brake plate 6b, and between the friction plate 7b and the brake plate 6c. Thus, the number of contact surfaces of the brake plates 6a, 6b, and 6c with the friction plates 7a and 7b is two, thereby allowing a reduction in the number of contact surfaces of the brake plates with the friction plates relative to the structure of the known art.

Hereinafter, a comparison of respective static friction torques caused by the structures of the known art and this embodiment of the present invention will be described. According to the structure of the known art as illustrated in FIG. 6, the plural brake plates and the plural friction plates move axially by gravity, and all four opposed surfaces serve as the contact surfaces. The following is a calculated example of the static friction torque at this time.

Firstly, as for the weight of the respective components, assume that the brake plates 6a, 6b, and 6c each weigh about 0.2 kg, and the friction plates 7a and 7b each weigh about 0.1 kg. Furthermore, assume that the coefficient μ of friction between the brake plates and the friction plates is 0.60, and the average friction radius r of the contact surfaces of the brake plates with the friction plates is 0.05 m.

Next, the normal load W (N) on each of these components is given by the following equations:

brake plate 6a: W6a=6c+7b+6b+7a (1)

friction plate 7a: W7a=6c+7b+6b (2)

brake plate 6b: W6b=6c+7b (3)

friction plate 7b: W7b=6c (4)

where W6a=0.2+0.1+0.2+0.1=0.6 kg=5.88 N; W7a=0.2+0.1+0.2=0.5 kg=4.90 N; W6b=0.2+0.1=0.3 kg=2.94 N; and W7b=0.2 kg=1.96 N.

The static friction torque T (N·m) applied to each of the contact surfaces of the respective components is given by the following equations:

static friction torque between 6a and 7a: T1=μ×W6a×r (5)

static friction torque between 7a and 6b: T2=μ×W7a×r (6)

static friction torque between 6b and 7b: T3=μ×W6b×r (7)

static friction torque between 7b and 6c: T4=μ×W7b×r (8)

where T1=0.60×5.88×0.05=0.1764 N·m; T2=0.60×4.90×0.05=0.147 N·m; T3=0.60×2.94×0.05=0.0882 N·m; and T4=0.60×1.96×0.05=0.0588 N·m.

Accordingly, the static friction torque Tsum (N·m) produced in the rotating shaft is the sum of the statistic friction torques T1 to T4, and therefore Tsum=T1+T2+T3+T4=0.4704 Nm.

On the other hand, according to the structure of this embodiment of the present invention as illustrated in FIG. 7, the plural brake plates and the plural friction plates move axially by gravity and have two contact surfaces. The following is a calculated example of the static friction torque at this time.

As for the weight of the respective components, assume that the brake plates 6a, 6b, and 6c each weigh about 0.2 kg, and the friction plates 7a and 7b each weigh about 0.1 kg. Furthermore, assume that the coefficient of friction μ between the brake plates and the friction plates is 0.60, and the average friction radius r of the contact surfaces of the brake plates with the friction plates is 0.05 m.

The normal load W (N) on each of these components is given by the following equations:

brake plate 6a: W6a=7a (9)

brake plate 6b: W6b=7b (10)

where W6a=0.1 kg=0.98 N; and W6b=7b=0.1 kg=0.98 N.

The static friction torque T (N·m) applied to each of the contact surfaces of the respective components is given by the equations (5) and (7), where static friction torque between 6a and 7a: T1=μ×W6a×r=0.60×0.98×0.05=0.0294 N·m; and static friction torque between 6b and 7b: T2=μ×W6b×r=0.60×0.98×0.05=0.0294 N·m. In addition, the static friction torque Tsum (N·m) produced in the rotating shaft is the sum of the statistic friction torques T1 and T2, and therefore Tsum=T1+T2=0.0588 N·m.

Thus, on the basis of the foregoing, comparing the static friction torques Tsum in the structures of the known art as illustrated in FIG. 6 and this embodiment of the present invention as illustrated in FIG. 7, (0.0588/0.4704)×100(%)=12.5(%). It is therefore obvious that, in this embodiment of the present invention, the static friction torque is drastically reduced relative to that of the known art.

As can be seen from the above, according to this embodiment of the present invention, portions (steps) having different diameters are provided on portions of the plural brake plate retainers engaging with the plural brake plates for supporting the lower surfaces of the plural brake plates falling by gravity so as to restrict an axial movable distance of the plural brake plates of the electromagnetic brake. Also, spaces are axially provided on the upper surfaces of the plural friction plates, and thus, at the time of rotation of the electric motor, the above-described respective spaces allow a drastic reduction in static friction torque.

Therefore, with this simple structure, it is possible to reduce losses in the motor and increase the efficiency of the motor, without addition of a special device and an increase in the number of components. Moreover, it is possible to reduce abnormal noise caused by the contact of the plural brake plates with the plural friction plates during rotation of the motor. In addition, in the case where an output shaft of the motor is manually turned at the time of performing assembly work for mounting couplings or the like on devices, and disassembly and inspection work while the motor is stopped, the reduction in static friction torque allows a reduction in the burden on the manual turning work and an improvement in maintenance performance.

### Second Embodiment

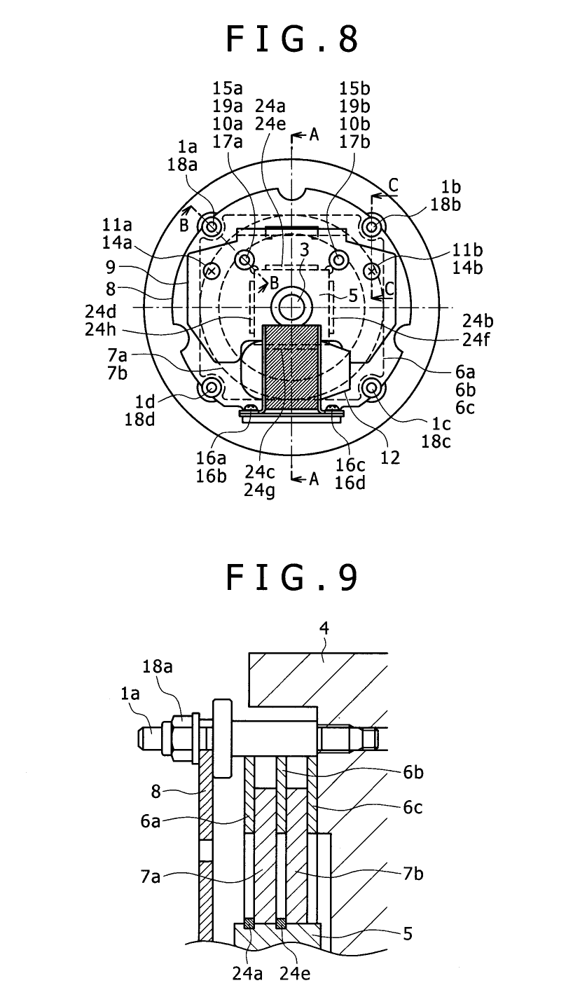

FIGS. 8 to 10 illustrate the structure of an electromagnetic brake according to a second embodiment of the present invention. FIG. 8 is a front elevation view of the electromagnetic brake according to the second embodiment of the present invention; FIG. 9 is a mounting diagram of friction plates, brake plates, and a hub of the electromagnetic brake according to the second embodiment of the present invention, as viewed from the section B-B of FIG. 8; and FIG. 10 is a structure diagram of an end bracket, the hub, the friction plates, the brake plates, and brake plate retainers when the electric motor with the electromagnetic brake according to the second embodiment of the present invention is used with its shaft in a vertical position.

The electromagnetic brake according to the second embodiment of the present invention includes a step structure of stepped portions 24a to 24h provided on the hub 5, in place of the stepped portions 23a to 23d respectively provided on the brake plate retainers 1a to 1d of the electromagnetic brake according to the first embodiment.

As shown in FIG. 8, the stepped portions 24a to 24d, and 24e to 24h are provided on four side surfaces of the hub 5 attached to the rotating shaft 3.

The location of the stepped portions will be described in detail. As shown in FIG. 9, the stepped portions 24a to 24d are each provided on a side surface of the hub 5, on a side of the friction plate 7a opposite the end bracket 4 of the electric motor, in other words, on a side of the friction plate 7a on which the pressure transmitter is disposed. Furthermore, the stepped portions 24e to 24h are each provided on a side surface of the hub 5, between the friction plate 7a and the friction plate 7b located on a side closer to the end bracket 4 than the friction plate 7a.

According to this electromagnetic brake, as shown in FIG. 10, in the case of using the motor with its shaft in a vertical position, during non-braking, the friction plate 7a falls by gravity to be held on the stepped portions 24a to 24d provided on the hub 5, and the friction plate 7b falls by gravity to be held on the stepped portions 24e to 24h provided on the hub 5. Thus, the number of the contact surfaces of the brake plates 6a, 6b, and 6c with the friction plates 7a and 7b is two, thereby allowing a reduction in static friction torque and dynamic friction torque acting opposite to the direction of motor torque.

Therefore, with this simple structure, it is possible to reduce losses in the motor and increase the efficiency of the motor. Moreover, it is possible to reduce abnormal noise caused by the contact of the plural brake plates with the plural friction plates during rotation of the motor. In addition, in the case where an output shaft of the motor is manually turned at the time of performing assembly work for mounting couplings or the like on devices, and disassembly and inspection work while the motor is stopped, the reduction in static friction torque allows a reduction in the burden on the manual turning work and an improvement in maintenance performance.

### Third Embodiment

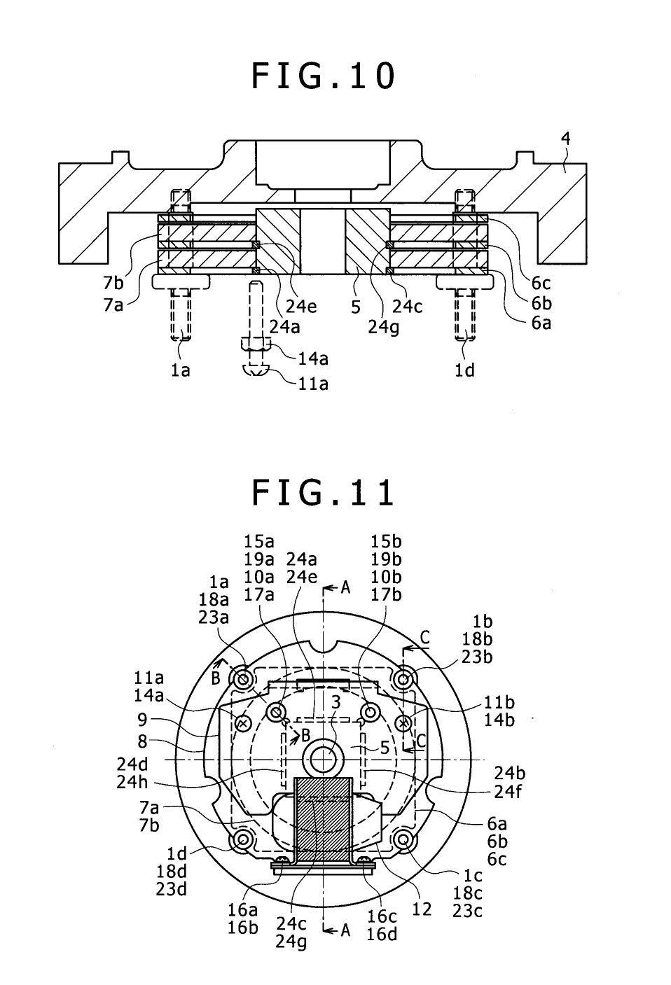

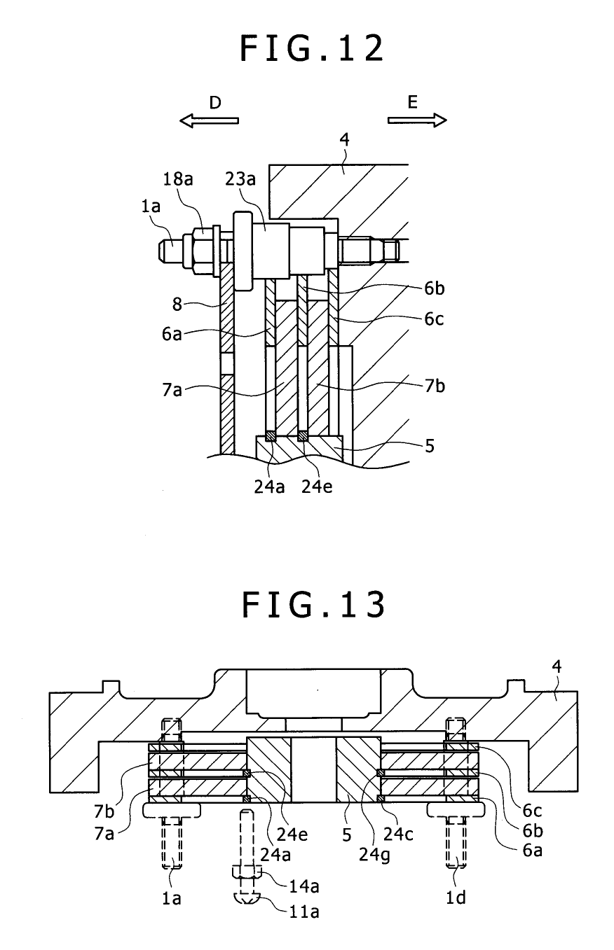

FIGS. 11 to 13 illustrate an electromagnetic brake according to a third embodiment of the present invention. FIG. 11 is a front elevation view of the electromagnetic brake according to the third embodiment of the present invention; FIG. 12 is an assembly diagram of friction plates, brake plates, brake plate retainers, and a hub of the electromagnetic brake according to the third embodiment of the present invention, as viewed from the section B-B of FIG. 11; and FIG. 13 is a structure diagram of an end bracket, the hub, the friction plates, the brake plates, and the brake plate retainers when the electric motor with the electromagnetic brake according to the third embodiment of the present invention is used with its shaft in a vertical position.

The electromagnetic brake according to the third embodiment of the present invention has a structure in which the stepped portions 24a to 24h are provided on the hub 5 in addition to the brake plate retainers 1a to 1d respectively including the stepped portions 23a to 23d in the first embodiment.

As shown in FIG. 11, the respective stepped portions 24a to 24h are provided on side surfaces of the hub 5 attached to the rotating shaft 3. Further, the brake plate retainers 1a to 1d respectively include the stepped portions 23a to 23d of the same shape.

Referring to FIG. 12, the location of the friction plates, the brake plates, the brake plate retainers, the hub, and the stepped portions will be described in detail. As shown in FIG. 12, the brake plate retainer la includes the stepped portion 23a. The stepped portion 23a is formed of a row of cylinders having different diameters, and has a structure with the respective cylinders increasing in diameter in order from a side closest to the end bracket 4. The differences in diameter among these cylinders form steps.

In this embodiment, the stepped portion 23a has a row of four cylinders having different diameters, and thus includes three steps. The stepped portion 23a is designed to retain the brake plates 6a, 6b, and 6c falling by gravity, in the case where the motor with the electromagnetic brake is used with its shaft in a vertical position.

It should be understood that the structure of the stepped portion is not limited to this embodiment, and a stepped portion not having the structure with cylinders arranged in a row is acceptable if the stepped portion has a step structure. It should be also understood that the number of steps is not limited to three and may be determined as appropriate depending on the numbers of the friction plates and the brake plates.

In addition to the above, according to this embodiment, the stepped portions 24a to 24d are each provided on a side surface of the hub 5 between the step located farthest from the end bracket 4 of the motor, of the steps of each of the stepped portions 23a to 23d provided on the brake plate retainers 1a to 1d, in other words, the step located closest to each pressure transmitter 11, and the friction plate 7a. Furthermore, the stepped portions 24e to 24h are each provided on a side surface of the hub 5, between the step adjacent to the step located farthest from the end bracket 4 of the motor, of the steps of each of the stepped portions 23a to 23d provided on the brake plate retainers 1a to 1d, in other words, the step adjacent to the step located closest to each pressure transmitter 11, and the friction plate 7b.

According to this electromagnetic brake, as shown in FIG. 13, in the case of using the motor with its shaft in a vertical position, during non-braking, the brake plates 6a, 6b, and 6c fall by gravity on the stepped portions 23a to 23d respectively provided on the brake plate retainers 1a to 1d, thereby forming a space in the rotating shaft direction between the friction plate 7a and the brake plate 6b, and between the friction plate 7b and the brake plate 6c. Furthermore, the friction plate 7a falls by gravity on the stepped portions 24a to 24d provided on the hub 5, and the friction plate 7b falls by gravity on the stepped portions 24e to 24h provided on the hub 5, thereby forming a space in the rotating shaft direction between the brake plate 6a and the friction plate 7a, and between the brake plate 6b and the friction plate 7b. Thus, the contact surfaces of the brake plates 6 with the friction plates 7 is eliminated, thereby allowing a drastic reduction in static friction torque and dynamic friction torque acting opposite to the direction of motor torque.

Therefore, with this simple structure, it is possible to reduce losses in the motor and increase the efficiency of the motor. Moreover, it is possible to reduce abnormal noise caused by the contact of the plural brake plates with the plural friction plates during rotation of the motor. In addition, in the case where an output shaft of the motor is manually turned at the time of performing assembly work for mounting couplings or the like on devices, and disassembly and inspection work while the motor is stopped, the reduction in static friction torque allows a reduction in the burden on the manual turning work and an improvement in maintenance performance.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. An electromagnetic brake comprising:
a hub attached to a rotating shaft and rotated with rotation of the rotating shaft;
a friction plate rotated in engagement with the hub and movable in an axial direction;
a brake plate sandwiching the friction plate, held against rotation by the rotating shaft, and movable in the axial direction;
a brake plate retainer for fixing the brake plate in a direction of shaft rotation and retaining the brake plate in an axially movable manner;
a pressure transmitter for receiving pressure and pressing the brake plate;
a pressure generating mechanism for generating pressure to be applied to the pressure transmitter;
a stress generating mechanism for generating stress against the pressure applied to the pressure transmitter; and
at least one of a brake plate retainer stepped portion provided on the brake plate retainer between adjacent ones of the brake plates, and a hub stepped portion provided on the hub on a side of the friction plate on which the pressure transmitter is disposed,
wherein the number of contact surfaces of the brake plates with the friction plate is reduced by the brake plate retainer stepped portion.

2. The electromagnetic brake according to claim 1, wherein the brake plate comprises a plurality of brake plates, and wherein the number of contact surfaces of the plurality of brake plates with the friction plate is reduced by the brake plate retainer stepped portion provided on the brake plate retainer between adjacent ones of the plurality of brake plates.

3. The electromagnetic brake according to claim 1, wherein the number of contact surfaces of the brake plates with the friction plate is reduced by the hub stepped portion.

4. The electromagnetic brake according to claim 2, wherein the number of contact surfaces of the plurality of brake plates with the friction plate is reduced by the hub stepped portion.

5. The electromagnetic brake according to claim 1, wherein the brake plate retainer stepped portion is formed of a row of cylinders having different diameters.

6. The electromagnetic brake according to claim 1, further comprising:
a mounting plate attached to the brake plate retainer and restricting an axial moving range of the brake plate; and
a movable plate engaging partially with the mounting plate,
the pressure generating mechanism and the stress generating mechanism being attached to the mounting plate and the movable plate,
wherein the pressure generating mechanism includes one end attached to the mounting plate and the other end having a tension applying member for urging the movable plate toward the friction plate, and
wherein the stress generating mechanism includes:
an electromagnet fixing portion fixed to the mounting plate; and
an electromagnet movable portion attached to the movable plate and sucking the movable plate against pressure of the tension applying member.

7. The electromagnetic brake according to claim 1, wherein the electromagnetic brake is a non-excitation brake in which current is allowed to pass by excitation to put the brake into a non-braking state.

8. An electric motor including: a stator fixed to a housing; a rotor rotated by a rotating magnetic field produced between the rotor and the stator; a rotating shaft rotated with the rotor; a bearing provided on an end bracket constituting a part of a casing together with the housing, and supporting the rotating shaft; and an electromagnetic brake for braking rotation of the rotating shaft; the electromagnetic brake comprising:
a hub attached to the rotating shaft and rotated with rotation of the rotating shaft;
a friction plate rotated in engagement with the hub and movable in an axial direction;
a brake plate sandwiching the friction plate, held against rotation by the rotating shaft, and movable in the axial direction;
a brake plate retainer for fixing the brake plate in a direction of shaft rotation and retaining the brake plate in an axially movable manner;
a pressure transmitter for receiving pressure and pressing the brake plate;
a pressure generating mechanism for generating pressure to be applied to the pressure transmitter;
a stress generating mechanism for generating stress against the pressure applied to the pressure transmitter; and
at least one of a brake plate retainer stepped portion provided on the brake plate retainer between adjacent ones of the brake plates, and a hub stepped portion provided on the hub on a side of the friction plate on which the pressure transmitter is disposed,
wherein the number of contact surfaces of the brake plates with the friction plate is reduced by the brake plate retainer stepped portion.

9. The electric motor according to claim 8, wherein the brake plate comprises a plurality of brake plates, and wherein the number of contact surfaces of the plurality of brake plates with the friction plate is reduced by the brake plate retainer stepped portion provided on the brake plate retainer between adjacent ones of the plurality of brake plates.

10. The electric motor according to claim 8, wherein the number of contact surfaces of the brake plates with the friction plate is reduced by the hub stepped portion.

11. The electric motor according to claim 9, wherein the number of contact surfaces of the plurality of brake plates with the friction plate is reduced by the hub stepped portion.

12. The electric motor according to claim 8, wherein the brake plate retainer stepped portion is formed of a row of cylinders having different diameters.

13. The electric motor according to claim 8, further comprising:
a mounting plate attached to the brake plate retainer and restricting an axial moving range of the brake plate; and
a movable plate engaging partially with the mounting plate, the pressure generating mechanism and the stress generating mechanism being attached to the mounting plate and the movable plate,
wherein the pressure generating mechanism includes one end attached to the mounting plate and the other end having a tension applying member for urging the movable plate toward the friction plate, and
wherein the stress generating mechanism includes:
an electromagnet fixing portion fixed to the mounting plate; and
an electromagnet movable portion attached to the movable plate and sucking the movable plate against pressure of the tension applying member.

14. The electric motor according to claim 8, wherein the electromagnetic brake is a non-excitation brake in which current is allowed to pass by excitation to put the brake into a non-braking state.
